(19) United States
(12) Patent Application Publication
(10) Pub. No.: US 2013/0144576 A1
(43) Pub. Date: Jun. 6, 2013

(54) Modeling of Laser Ablation and Plume Chemistry in a Boron Nitride Nanotube Production Rig

(71) Applicant: U.S.A. as represented by the Administrator of the, Washington, DC (US)

(72) Inventors: Peter A. Gnoffo, Yorktown, VA (US); Catharine C. Fay, Yorktown, VA (US)

(73) Assignee: U.S.A. as represented by the Administrator of the National Aeronautics and Space Admimistration, Washington, DC (US)

(21) Appl. No.: 13/673,360

(22) Filed: Nov. 9, 2012

Related U.S. Application Data
(60) Provisional application No. 61/558,189, filed on Nov. 10, 2011.
(60) Provisional application No. 61/658,122, filed on Jun. 11, 2012.
(60) Provisional application No. 61/661,405, filed on Jun. 19, 2012.

(51) Int. Cl. G06F 17/50

(52) U.S. Cl. CPC G06F 17/5009
USPC 703/2

(57) ABSTRACT

A pressurized vapor condensation (PVC) process for production of Boron Nitride Nanotubes (BNNT) is modeled utilizing a modified hypersonic flow solver. The results of the modeling may be utilized to adjust operating parameters of the PV process of BNNT production rig. Utilizing the modeling reduces the time and expense associated with setup of a BNNT production rig.

### CROSS-REFERENCE TO RELATED APPLICATIONS

This application claims the benefit of and priority to U.S. Provisional patent application Ser. No. 61/558,189 filed on Nov. 10, 2011; Provisional Patent Application Ser. No. 61/658,122 filed on Jun. 11, 2012; and Provisional Patent Application Ser. No. 61/661,405 filed on Jun. 19, 2012, the contents of all hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### FIELD OF THE INVENTION

The present invention relates to modeling of production of nanotubes, and in particular to the modeling of laser vaporization and plume chemistry in a boron nitride nanotube production rig.

### BACKGROUND OF THE INVENTION

A key enabler of economic access to space is the use of multifunctional lightweight materials. Boron Nitride Nanotube (BNNT) composites offer distinct advantages for enhanced survivability during long-term exploration flights. BNNTs are structurally a close analog of carbon nanotubes (CNTs), with the carbon atoms alternately substituted with boron and nitrogen atoms. BNNTs are durable at low temperatures in space (−157° C.) and exhibit good thermal stability to 800° C. with a low coefficient of thermal expansion. Their strength-to-weight ratios and stiffness are greater than 95 percent of carbon nanotube values within elastic modulus approaching 1 TPa. Boron nitride nanotube fibers are calculated to be the world's strongest structural fiber above 400 C.

Boron has one of the largest neutron capture cross-sections of all elements in the Periodic Table. Nitrogen has a larger neutron capture cross-section than carbon. Consequently, BNNT materials have great potential for radiation shielding applications. Their high strength also makes BNNT fabrics well-suited for deployable aerobrake surfaces, offering dual use opportunities for radiation shielding in transit and deployable aerobrake on entry into a planetary atmosphere. These materials can enable development of aerospace structures with both impact resistance and radiation shielding capabilities, thereby improving reliability and durability for long-term missions.

Various processes have been developed for producing BNNT. One type of BNNT production utilizes a high-temperature, pressurized vapor condensation (PVC) method as disclosed in Smith et al. U.S. Patent publication 2010/0192535, the entire contents of which are hereby incorporated by reference. The novel synthesis method described in the Smith 535 application produces thin, long, high aspect ratio, highly crystalline BNNTs using a conventional laser at high pressure. Apparatus for the BNNT production are disclosed in Smith et al. U.S. Patent publication 2012/0175242, the entire contents of which are incorporated by reference herein. The PVC method appears to minimize tube defects and create exceptionally long (order mm) tubes. The synthesis of longer tubes is advantageous for structural reinforcement applications, where it is more likely that the desired strength properties will extend from the nanoscale to the macroscale.

### BRIEF SUMMARY OF THE INVENTION

One aspect of the present invention is a method of modeling macroscopic details of the PVC production process (plume formation, species densities, temperatures, flow rates) ensuing from laser energy deposition on a boron sample in a pressurized test rig. The simulations initially assume axisymmetric, single-phase flow. The initial simulation does not include the possible presence of boron droplets sputtered from the boron source or the nucleation of solids from the plume. The present invention provides a way to model the macroscopic environment in order to optimize BNNT production rates to create an industrial-scale processing capability. The modeling focuses on the flow rates of the BN vapor as a function of pressure to potentially explain improved quality as nanotubes produced by the PVC method.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a schematic view of a PVC system for producing boron nitride nanotubes (BNNT);

FIG. 2 is a schematic view showing a boron droplet being vaporized by a laser during the PVC process;

FIG. 3 shows boundary conditions and a grid utilized to model a pressure chamber utilized in the PVC process;

FIG. 3a shows a perspective of a 5 degree wedge shaped domain;

FIG. 3b shows the domain above the 1 mm radius irradiated spot;

FIG. 4 is a schematic of energy flux crossing the interface of the droplet surface and atmosphere at the base of the plume;

FIG. 5 is a graph showing contour lines of BN flow rates in a plume over an irradiated droplet of boron;

FIG. 6a is a graph showing centerline variation of the mass fraction of BN at T=0.04 seconds;

FIG. 6b shows centerline variation of the flow rate of BN at T=0.04 seconds;

FIG. 6c shows centerline variation of the temperature at T=0.04 seconds;

FIG. 6d shows centerline variation of temperature evolution on fine and medium grid solutions;

FIG. 7a is a graph of plume temperature at 0 psig and 200 psig;

FIG. 7b is a graph showing mass fraction of IN at 0 psig and 200 psig;

FIG. 8a is graph showing flow rate of BN at 0 psig and 200 psig;

FIG. 8b is a graph showing now rate of B and B2 at 0 psig and 200 psig;

FIG. 9a is a graph showing variation of maximum BN mass fraction as a function of pressure and atmospheric constituents for total chamber pressure;

FIG. 9b is a graph showing variation of maximum BN mass fraction as a function of pressure and atmospheric constituents for nitrogen partial pressure in the chamber;

FIG. 10a is a graph showing the variation of maximum vertical flow rate of BN as a function of total chamber pressure and atmospheric constituents;

FIG. 10b is a graph showing the variation of maximum vertical flow rate of BN as a function of nitrogen partial pressure in the chamber and atmospheric constituents;

FIG. 11a is a graph showing variation of maximum temperature as a function of total chamber pressure and atmospheric constituents;

FIG. 11b is a chart showing variation of maximum temperature as a function of nitrogen partial pressure in the chamber and atmospheric constituents;

FIG. 12a is a graph showing centerline variation of mass fraction of BN in a rising plume of gas over an irradiated droplet of boron as a function of gas chemistry model;

FIG. 12b is a graph showing centerline variation of vertical flow rate of BN in a rising plume of gas over an irradiated droplet of boron as a function of gas chemistry model;

FIG. 12c is a graph showing centerline variation of integrated flow of BN across a plume of gas over an irradiated droplet of boron as a function of gas chemistry model;

FIG. 12d is a graph showing centerline variation of integrated flow of B and B2 across a plume of gas over an irradiated droplet of boron as a function of gas chemistry model;

FIG. 13a is a graph showing centerline variation of temperature in a rising plume of gas over an irradiated droplet of boron as a function of laser power;

FIG. 13b is a graph showing centerline variation of mass fraction of BN in a rising plume of gas over an irradiated droplet of boron as a function of laser power;

FIG. 13c is a graph showing centerline variation of mass fraction of B in a rising plume of gas over an irradiated droplet of boron as a function of laser power;

FIG. 13d is a graph showing centerline variation of mass fraction of B2 in a rising plume of gas over an irradiated droplet of boron as a function of laser power;

FIG. 14a is a graph showing a variation of centerline and integrated production rates (centerline flow rate of 13N) in a rising plume of gas over an irradiated droplet of boron as a function of laser power with dashed lines indicating blowing rate at the surface;

FIG. 14b is a graph showing a variation of centerline and integrated production rates (centerline flow rate of B and B₂) in a rising plume of gas over an irradiated droplet of boron as a function of laser power with dashed lines indicating blowing rate at the surface; and

FIG. 14c is a graph showing a variation of centerline and integrated production rates (integrated flow rate of BN across plume) in a rising plume of gas over an irradiated droplet of boron as a function of laser power with dashed lines indicating blowing rate at the surface;

FIG. 14d is a graph showing a variation of centerline and integrated production rates (integrated flow rate of B and B₂ across plume) in a rising plume of gas over an irradiated droplet of boron as a function of laser power with dashed lines indicating blowing rate at the surface; and

FIG. 15 is a graph showing profiles of B and BN vapor pressure non-dimensionalized by the corresponding saturation vapor pressure as a function of distance above the droplet at p₀=200 psig.

### DETAILED DESCRIPTION OF THE INVENTION

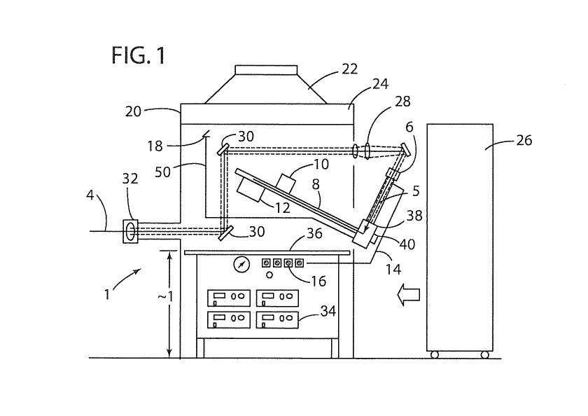

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention comprises simulation of the PVC process of a BNNT production rig utilizing computer modeling/simulation. The results of the simulation can be utilized to set up and/or adjust the parameters of the BNNT production rig. Setting up a BNNT production rig can be time-consuming. Also, changing parameters after initial set up can also be time consuming.

Simulation of a BNNT production rig according to the present invention involves modifying a hypersonics flow solver such as NASA's LAURA code. The modifications include: (1) addition of boron species (B, BN, B₂) to thermodynamic and transport property data sets; (2) resetting a surface energy balance equation under a laser radiation source based on equilibration of atomic boron vapor pressure with a liquid boron source; (3) adding buoyancy terms (gravitational field) to the momentum equations; and, (4) adding a porous wall boundary condition to mimic a pressure relief valve in the system to maintain constant pressure as mass and energy are added to the system.

With reference to FIG. 1, a pressurized vapor condensation (PVC) production system 1 utilizes a laser beam 4 that enters a pressurized chamber 5 through a window 6 at the top of the chamber 5. A feedstock 8 of bundled boron fibers is slowly guided into the pressure chamber 5 using a target feed drive 10 and target adjusters 12. A nitrogen supply line 14, flow controls 16, and exhaust flow meter 18 are utilized to maintain a constant pressure environment in the pressure chamber 5. The PVC production system 1 comprises a structure 20 having an exhaust 22 that is fluidly connected to an exterior of the building, and a 0.3 micron HEPA filter 24. The system also includes a sliding, bullet-proof, protective shell 26. The system 1 further includes beam-shaping optics 28 and turning mirrors 30 for directing and controlling laser beam 4. The system further includes a pica-motor-controlled turning mirror 32. Electronic controls 34 provide target and beam manipulation. The components may be mounted on an optics table 36. The system further includes a condenser loop 38 and a viewing port in the form of one or more video cameras 40. The temperature in the pressurized chamber 5 can also be varied in the simulation.

It will be appreciated that it ma be time consuming and/or difficult to change input parameters such as chamber pressure, laser beam power and/or laser beam shape, feed rate of the boron fibers, position of the condenser loop, nitrogen flow rate and nozzle location once the system 1 is set up.

### NOMENCLATURE

The following nomenclature is used herein:

Roman Symbols
Aᵣ, Bᵣ Arrhenius rate parameters, Eq. 1
c mass fraction
g gravitational acceleration
h enthalpy per unit mass
ΔH_{f} heat of formation
ΔH_{vap,B}⁰ heat of vaporization for boron
k reaction rate coefficient
k_{c} equilibrium constant
\dot{m} mass loss rate, mg/mm²-hr
{tilde over (\dot{m} integrated \dot{m}, mg/hr
n number of moles
p pressure
q heating rate
r radius
R universal gas constant
t time
T temperature
Vₙ velocity normal to wail
z height above droplet

Greek Symbols
α absorbed radiation fraction.
ε emissivity
ρ density
σ Stefan-Boltzmann constant
χ mole fraction

Subscripts
0 conditions in chamber
act activation
b backward rate
cond conduction
conv convection
f forward rate
melt property of droplet
r reaction number
s species
sat saturation
vap vapor
w wall

### Formation of Molten Boron Droplet

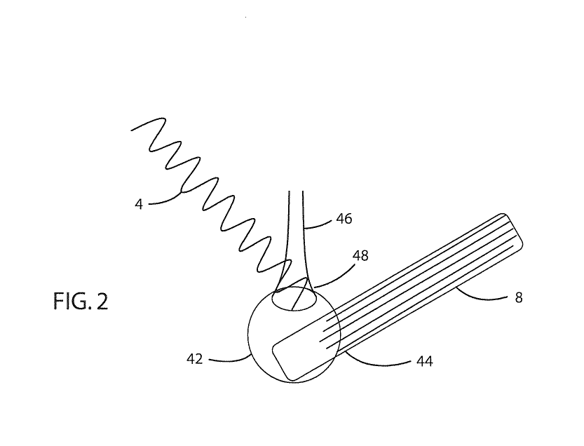

An illustration of the interaction of the laser beam 4 and the boron fiber bundle 8 (not to scale) is presented in FIG. 2. The laser power and focus is adjusted to strike the boron fiber bundle 8 in a way that enables a boron droplet 42 to suspend by surface tension from the end 44 of the fiber bundle 4. The laser beam 4 then directly strikes only the droplet 42. Energy is conducted and re-radiated from the droplet 42 into the fiber bundle 8. In a perfectly tuned system all mass loss is through vaporization, the melt rate to replenish the droplet 42 exactly matches the mass loss rate through vaporization, and the fiber bundle 8 is continuously fed into the chamber 5 to keep the interaction location fixed within the chamber 5. If delivered power is too great, the droplet 42 boils and drops off the end 44 of the fiber bundle 8. Any such perfectly tuned combination of delivered laser power and constant feed rate of the boron fiber bundle 8 into the chamber 5 without any droplets falling off is considered a steady state vaporization condition. It requires a balance of mass conversion from solid phase to liquid phase to gas phase. It requires a corresponding balance of energy to drive these phase changes from the laser beam 4 to the droplet 42 to the fiber bundle 8 along with convective and radiative losses to the surrounding system. The simulations described below model steady state vaporization.

### Formation of Boron Nitride Nanotubes on Condenser Wire

Also shown in FIG. 2 is a plume 46 of hot has fed by vaporization off the droplet 42. The plume 46 rises by buoyancy in which the low density, hot gas in the plume base 48 is displaced vertically by the higher density, cooler nitrogen gas surrounding it. As the nitrogen is drawn in to the base 48 of the plume 46 it is heated and reacts with the boron vapor. Not shown in FIG. 2 is a condenser wire loop 38 which serves as a nucleation site for BNNTs and other boron species when the plume 46 flows over it. The condenser wire loop 38 can be pulled like a clothesline on pulleys within the chamber 5. This action draws condensate out of the way of the plume 46 and exposes fresh nucleation sites. In the configuration shown in FIG. 1 the condensate is harvested after the system is powered off and the chamber 5 can be de-pressurized and opened. Simulations of the gas phase in the plume 46 are intended to define the constituents and thermodynamic environment available for nucleation.

### Modeling

### Computational Domain, Grid, and Boundary Conditions

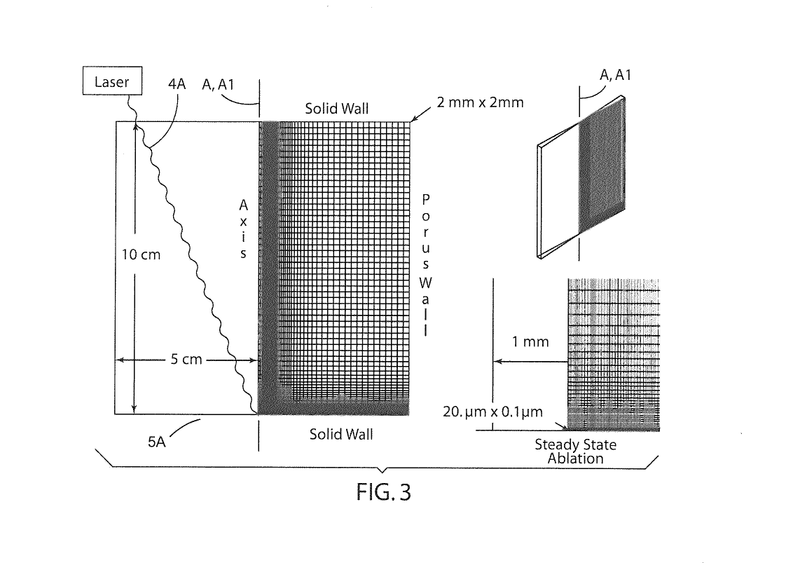

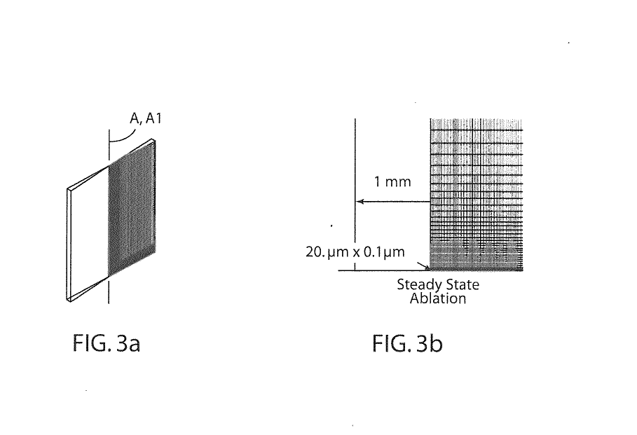

The present invention utilizes LAURA (Langley Aerothermodynamic Upwind Relaxation Algorithm) known computer software developed by NASA (National Aeronautics and Space Administration). The LAURA Users Manual: 5.4-54166, NASA/TM-2011-217092, is incorporated herein by reference in its entirety. While the embodiment described uses LAURA, other hypersonics flow solvers could also be utilized. The discretization of an idealized chamber 5A is presented in FIG. 3. The model assumes that the actual plume 46 is axi-symmetric and that its evolution within the actual chamber 5 up to the condenser wire 38 is not strongly affected by the orientation of chamber walls far removed (50 to 100 plume diameters) from the plume axis. This assumption enables creation of an idealized, axi-symmetric chamber 5A to simplify the simulation and enable parametric investigations in reasonable time. The axis A1 of the chamber 5A corresponds to the axis A of the plume as seen in the center of the figure. In the illustrated example, the idealized chamber radius is 5 cm, and the idealized chamber height is 10 cm. The radius of the laser spot in the droplet is set to 1 mm for the simulations. At time t=0 the chamber 5A is filled with molecular nitrogen at temperature T₀, pressure p₀, and density p₀ with zero velocity throughout.

The top and bottom boundaries, except for the 1 mm radius spot heated by the laser 4A is treated as a cold (T_{w}=300. K), no-slip wall. Species mass fractions at the walls are computed assuming chemical equilibrium at the wall temperature and the locally computed elemental mass fractions from the elemental continuity equations. The left boundary is the axis of symmetry. The right boundary is treated as a porous wall to maintain constant pressure in the chamber in an environment in which mass and energy are added continuously. In the actual chamber nitrogen feed and purge lines 50 purge gas from the chamber and replace it with molecular nitrogen to maintain constant pressure. The porous wall boundary condition replaces this function while maintaining an axisymmetric flow environment. It computes the difference between the local value of pressure at the wall and the target pressure, Δp_{w}=p_{w}−pₜₐᵣ. It is derived from Bernoulli's Equation and assumes an idealized porosity with zero losses. If Δp_{w}>0 then flow at local conditions is directed out of the chamber with velocity Vₙ=−\sqrt{2Δp_{w}/ρ_{w}}. If Δp_{w}<0 then pure nitrogen flow at T₀=300 K is directed into the chamber with velocity Vₙ=\sqrt{−2Δp_{w}/ρ₀}.

FIG. 3a shows a perspective of a 5 degree wedge shaped domain. In FIG. 3b the domain above the 1 mm radius irradiated spot is featured, in this simulation the droplet surface has no curvature. In fact, the largest and potentially significant difference between this idealized domain and the actual domain is that the idealized domain treats the irradiated surface of the droplet as a spot on the floor of the chamber. In the actual chamber, gas can rise from beneath the droplet suspended from the end of the fiber bundle. In the present simulations, gas flows along a cold wall before feeding the base of the plume. The cell size normal to the wall in the nominal grid is 10⁻⁷ m. The tight spacing here helps maintain stability in the very early evolution of the plume when the spot is first irradiated. The cell size tangent to the wail over the 1 mm radius is a constant 2×10⁻⁵ m. Mesh size grows in the radial direction by a factor of 1.1 beyond the 1 mm edge of the droplet. Mesh size grows by the same 1.1 factor in the vertical direction. Mesh growth is terminated when the cell dimension achieves 2 mm. This grid generation algorithm maintains a fine spacing in the radial direction in the core of the chamber to capture diffusion across the edge of the plume. The boundary condition across the 1 mm radius at the bottom of the domain defines the surface response model. The formulation of this boundary condition is discussed in more detail below.

### Gas Properties

The nominal atmosphere inside the pressurized idealized chamber is 100% N₂. Parameter studies also consider the effects of noble gas (He or Ar) in the chamber. The B−N system is assumed to include (B, BN, N, N₂, and B₂)—all in the gas phase. An option for multiple phases in the plume is not included, such that the simulations of the present invention describe conditions un to the first nucleation event.

Curve fits for thermodynamic properties of these species are obtained utilizing known software. Transport properties are calculated as functions of collision cross-sections and temperature. Collision cross-sections for the B—N system may be approximated by using the corresponding collision cross-sections in the C—N system along with the appropriate molecular weights of the colliding pairs in the B—N system. A spot check with an evaluation of B—B cross-sections at 2000 K indicate they are approximately 20% higher than the corresponding C—C cross sections.

In the case of flow in chemical equilibrium the elemental continuity equations are solved and a free energy minimization is implemented in every control volume to solve for species mass fractions as a function of elemental mass fraction, temperature, and pressure.

Equilibrium simulations had been run with only a four species model that neglected B₂. These simulations indicated that the presence of B₂ significantly diminished the amount of BN in the upper part of the plume. A quick check on the possible influence of reaction path to equilibrium was then initiated. This was done to determine how BN, created in the hot base of the plume, was consumed as the gas rises and cools. Is it credible that BN levels could freeze (remain relatively constant) as the plume rises and cools, even at elevated pressures? This question regarding the qualitative effects of kinetics in a rising plume is addressed by approximating a kinetic model for the B—N system with a C—N system template as shown in Table 1. (An experimentally verified kinetic model for the B—N system has not yet been identified.) Column 1 is the reaction number, Column 2 shows a proposed reaction in the B—N system and column 3 shows the corresponding template reaction from the C—N system. Column 4 presents the pre-exponential factor of the Arrhenius rate formulation as defined for the template reaction, where the Arrhenius rate coefficients for forward and backward reactions are given by the following Eqs. 1 and 2.

k_{f,r}=AᵣT^{Br}exp(−T_{r,act}/T)

k_{b,r}=k_{f,r}/K_{c,r}(T)

The following Eq. 3 provides activation temperature T_{t,act} for reaction r is approximated using the heats of formation of reactants and products compiled in Table 2.

$${T}_{r , act} \approx {T}_{r}^{i} = ( \text{?} {n}_{s , r} Δ {H}_{f , s} - \text{?} {n}_{s , r} Δ {H}_{f , s} ) / R$$

$$\text{?} \text{indicates text missing or illegible when filed}$$

Column 5 of Table 1 presents the proposed activation temperature for the B—N system reaction as calculated from Eq. 3. Column 6 presents the activation temperature used in the template C—N system and column 7 presents the value of T*ᵣ as a reference condition for the credibility of the approximation in Eq. 3. T*ᵣ is within 3% of the experimentally determined activation temperature for reactions 1-3. The approximation is not so good with reactions 4 and 5 where differences are 47% and −25%, respectively. The dissociation of N₂ by collision with any generic partner is included in the model. It does not appear in Table 1 because its Arrhenius rate coefficients are readily available and do not require a template.

TABLE 1
Chemical Kinetic Models for B—N and C—N Systems

| | B—N system | C—N system | pre-expon | proposed | template | template |
|---|---|---|---|---|---|---|
| r | proposed reactions | template reactions | Aᵣ | T_{r,a,t}, K | T_{r,act}, K | Tᵣ*, K |
| 1 | B₂ + M <=> 2B + M | C₂ + M <=> 2C + M | 3.7 10¹⁴ | 34914 | 69900 | 71637 |
| 2 | BN + M <=> B + N + M | CN + M <=> C + N + M | 2.5 10¹⁴ | 66834 | 87740 | 90717 |
| 3 | N₂ + B <=> BN + N | N₂ + C <=> CN + N | 1.1 10¹⁴ | 46870 | 23200 | 22986 |
| 4 | BN + B <=> B₂ + N | CN + C <=> C₂ + N | 5.0 10¹³ | 31919 | 13000 | 19077 |
| 5 | B₂ + N₂ <=> 2BN | C₂ + N₂ <=> 2CN | 7.1 10¹³ | 14950 | 5330 | 3993 |

TABLE 2
Enthalpy of Formation

| species | ΔH_{f}, kJ/mol | species | ΔH_{f}, kJ/mol | species | ΔH_{f}, kJ/mol |
|---|---|---|---|---|---|
| B | 560 ±12 | C | 716.67 ± .46 | N | 472.68 ± 0.1 |
| BN | 477 ± 125 | CN | 435.1 ± 10 | | |
| B₂ | 829.7 ± 33.5 | C₂ | 837.7 ± 3.8 | N₂ | 0 |

### Material Response Model

Two material response models have been tested. The first one simply allows the user to specify a uniform droplet surface temperature and a uniform vaporization mass flow rate as determined from experimental observation. The second one enables the computation of a spatially varying droplet temperature and mass flow from the droplet using a steady-state vaporization/melt approximation. An equilibrium vapor pressure is assumed for gaseous boron B(g) over the molten boron droplet B(l) at the tip of the solid boron fiber bundle. The boiling point of boron at p=1bar=10⁵ N/m² is T_{vap.}=4137.895K and the corresponding enthalpy of vaporization is ΔᵥₐₚH_{B}⁰=480.344 kJ/mol. (Uncertainties were not provided for these calculated values. For reference, the uncertainty in the heat of formation of boron gas is 12 kJ/mol.) The Clausius-Clapeyron Equation is used to compute the equilibrium vapor pressure of boron as a function of droplet surface temperature, as provided by the following Eq. 4.

$$\text{?} \frac{pB , 2}{pB , 1} = - \frac{\text{?} \text{?}}{R} ( \frac{1}{{T}_{2}} - \frac{1}{{T}_{1}} )$$

$$\text{?} \text{indicates text missing or illegible when filed}$$

Table 3 provides a convenient reference for the boiling point of boron computed with Eq. 4 as a function of pressure levels. Chamber pressure in units of psig are used throughout, consistent with the experimental apparatus. Table 3 also shows these pressures in units of Pa and atmospheres.

TABLE 3
Boiling Point of Boron

| p, psig | p, P [symbol] | p, [symbol] m | T, K |
|---|---|---|---|
| 0 | 1.01325 10⁵ | 1 | 4138. |
| 50 | 4.46062 10⁵ | 4 [symbol] 4 | 4629. |
| 100 | 7.90800 10⁵ | 7.8 | 4852. |
| 200 | 14.8028 10⁵ | 14.6 | 5122. |
| 400 | 28.5928 10⁵ | 28.2 | 5439. |
| 800 | 56.1715 10⁵ | 55.4 | 5808. |

[symbol]

indicates data missing or illegible when filed

A rigorous simulation would track the energy flux from the gas through the droplet and into the fiber bundle. A simplifying steady-state vaporization approximation is made to facilitate parametric studies. In the steady state vaporization approximation an energy balance across the liquid-gas interface of the droplet is evaluated.

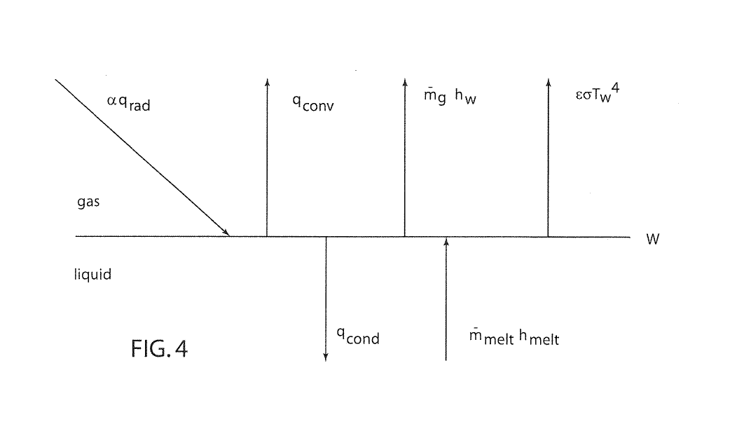

With reference to FIG. 4, the absorbed energy entering the interface from above (the gas side) is the laser radiation αq_{grad}. The energy leaving the interface through the gas phase by molecular transport processes is q_{conv}. This term includes conduction and diffusion of multiple species in the gas phase. The energy re-radiated from droplet surface into free space is εσT_{w}⁴. The energy carried by vaporization into the base of the rising plume is \dot{m}_{g}h_{w}. The energy approaching the interface from the liquid below is carried by the melt mass flux \dot{m}ₘₑₗₜhₘₑₗₜ. The energy leaving the interface into the droplet is represented by q_{cond}. In the steady state approximation it is assumed that the melt rate is balanced by the vaporization rate so that the size of the droplet remains constant and there is no accumulation of energy in the droplet. Also, the conduction of energy into the droplet q_{cond} is assumed to balance the melt flux of energy approaching the interface \dot{m}ₘₑₗₜhₘₑₗₜ. All of these balances, represented by Eq. 5 below with q_{cond} canceling \dot{m}ₘₑₗₜhₘₑₗₜ, implicitly assume a one-dimensional variation of properties.

αq_{rad}=εσT_{w}⁴+q_{conv}+\dot{m}_{g}h_{w}

In reality there are losses through the sides of the droplet that are not simulated in the idealized domain. Consequently, the effect of these losses is included in the parameter α which already includes the absorption of radiation from the laser at a nonorthogonal angle to the droplet surface. α is believed to be a parameter that can be adjusted to match observed recession rates of the boron fiber bundle. It has not yet been confirmed through testing that the assumption of a constant droplet size (\dot{m}ₘₑₗₜhₘₑₗₜ) can be achieved in the PVC process.

### Numerical Method

NASA's program LAURA simulates the coupled radiation and ablation in the shock layer over a vehicle entering a planetary atmosphere at hypersonic velocities. This code was utilized for simulation of the production rig because the algorithms for dealing with high temperature, reacting gas mixtures and tightly coupled ablation and radiation for carbon based ablators are already well established. It uses Roe's averaging with Harten's entropy fix and Yee's Symmetric Total Variation Diminishing algorithms for solving inviscid flux. Central differences are used for viscous flux terms.

Simulation of a BNNT production rig according to the present invention involves modifying a hypersonics flow solver such as NASA's LAURA code. The modifications include: (1) addition of boron species (B, BN, B₂) to thermodynamic and transport property data sets; (2) resetting a surface energy balance equation under a laser radiation source based on equilibration of atomic boron vapor pressure with a liquid boron source; (3) adding buoyancy terms (gravitational field) to the momentum equations; and, (4) adding a porous wail boundary condition to mimic a pressure relief valve in the system to maintain constant pressure as mass and energy are added to the system. Items 1, 2, and 4 are discussed above. Item 3 is accommodated by adding the source term ρg to the z-momentum equation.

Conversion of a dependent variable set from species densities and energy to species partial pressures and energy have addressed some preconditioning issues in the application of a hypersonics flow solver to a nearly incompressible flow domain though some stability issues persist. These issues are addressed by running simulations with first-order time accuracy with Δt=1. 10⁻⁶ s. Ten subiterations are engaged before advancing to the next time step. Each subiteration use implicit line relaxation extending from the lower wall and droplet surface to the upper wall.

### Plume Simulations

### Parameter Space

Nominal conditions for simulated PVC process are p₀=200 psig, T₀=300 K, ρ₀=16.617 kg/m3, in a molecular nitrogen atmosphere. An elevated pressure in the PVC method has been found to yield exceptionally long nanotube lengths (estimated to at least 1 mm bawd on ability to spin fibrils into 1 mm diameter yarn). (see Smith, M. W., Jordan, K. C., Park, C., Kim, J.-W., Lilleheil P. T., Crooks, R., and Harrison, J. S., “Very long single- and few-walled boron nitride nanotubes via the pressurized vapor/condenser method,” Nanotechnology, Vol. 20, No. 50, November 2009. pp. 1-6). Nanotubes may also be created at atmospheric pressure levels but reported tube lengths at this condition are much shorter at 100 nm.

Simulations according to the present invention of the macroscopic environment provide insights into the possible mechanisms through which the nucleation rates are enhanced. Elevated pressures are believed to increase the collision rates of the component particles with the nucleation site. As discussed below, raising the pressure levels also raises the level of BN molecules directly available for nucleation without the need to catalyze dissociation of N₂ in a liquid boron nucleation site. If condensation of BN molecules at the tip of a developing nanotube is a possible growth mechanism then it may prove to be a critical process to enable growth of exceptionally long BN nanotubes.

In the examples given herein, the parameter space for which simulations are executed include chamber pressure levels of 0, 50, 100, 200, 400, and 800 psig. The simulated chamber atmospheres include χN₂=1, χN₂=0.5 and χHe=0.5, and χN₂=0.5 and χN₂=0.5 and χ_{Ar}=0.5 The power levels delivered to a 1 mm radius spot after subtracting losses include 0.05, 0.1, 0.2, and 2.0 kW. Higher power levels (e.g. 5.0 kW) could also be utilized. These simulations provide insight regarding their effect on the plume environment. The flow rates of BN gas in the plume are highlighted because of their potential importance to a tip growth mechanism. Only simulations using the steady state vaporization boundary condition are provided here, in which mass loss rate and droplet temperature are computed as part of the boundary condition.

### Grid Convergence for Nominal Conditions

An example of the grid generation algorithm for the nominal condition simulations is described above. A grid convergence study was conducted to evaluate any effects of grid resolution on computed results. The fine grid and coarse grids use minimum mesh sizes that are a factor of two finer and coarser, respectively, than the nominal grid. The fine and coarse grids use a factor of two smaller and greater, respectively, time step of Δt=1. 10⁻⁶s used on the nominal grid simulations. The maximum allowed grid size, 2 mm, is unchanged among all three grids. Consequently, grid resolution far from the plume is equivalent. The study herein focuses on resolution at the plume base and across the radial edge of the rising plume.

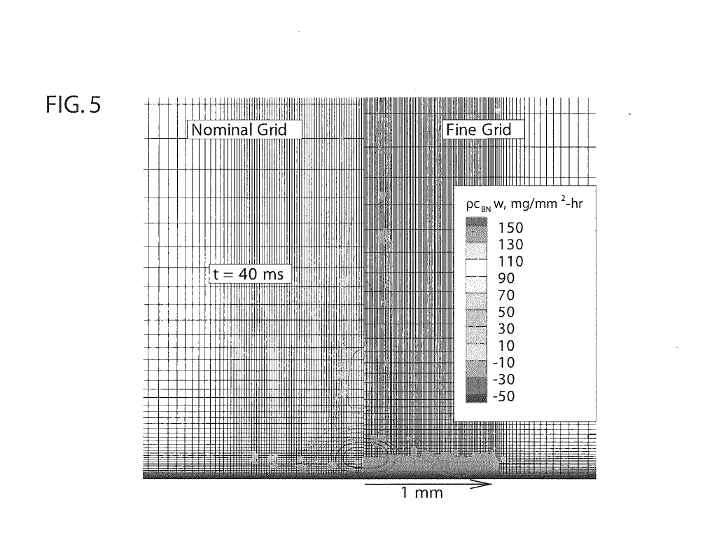

FIG. 5 presents a composite contour plot of the nominal grid solution on the left and the fine grid solution on the right. The plume axis rises vertically in the center of the figure. The contours indicate the vertical flow rate of the BN species in units of mg/mm²-hr. (Nanotube production rates are often given in units of mg/hr. Because the base radius of the plume base is 1 mm these units provide a convenient reference.) Note the concentric oval contour lines at the base of the plume. Negative values here indicate a recirculating flow in which the velocity is approaching the droplet surface. The foot of the plume is fed by cold, molecular nitrogen. As it encounters the thermal layer above the irradiated spot the temperature increases sufficiently to enable some dissociation of molecular nitrogen that reacts with atomic boron rising from the droplet. A slight, unsteady pulsing of the plume is evident early in its evolution on the fine grid. The pulsing is not evident in the nominal grid simulation and eventually damps out on the fine grid. (Unsteady motion persists at higher absorbed laser power levels as discussed below.)

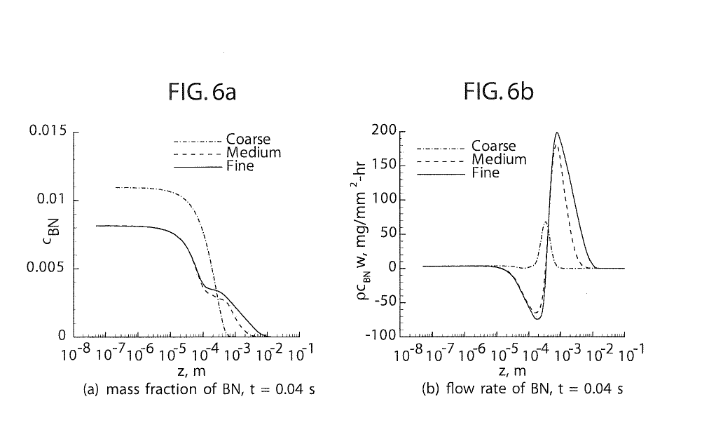

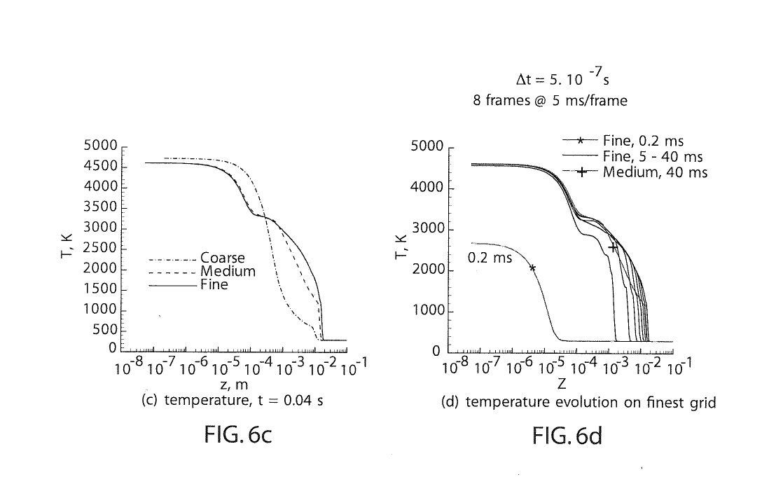

FIG. 6 presents the centerline variation of plume properties as a function of distance above the droplet. A log scale is used to focus on chemistry at the plume base. The coarse grid solution shows higher temperature and BN mass fraction at the base of the plume compared to the nominal and fine grid solutions. The coarse grid solution clearly dissipates the c_{BN} and temperature profile as the plume rises. In contrast, grid convergence is substantially achieved at the base of the plume for z<0:1 mm across the recirculating flow as judged by agreement of the medium and fine grid results. FIG. 6 shows the evolution of the temperature profile at 5 ms intervals from the fine grid. The first dashed line in this figure shows a profile very early in the development of the plume at 0.2 ms. The second dashed line in this figure indicates the medium grid solution at 40 ms. For 0:1<z<1 mm the medium grid solution starts to dissipate the higher curvature elements of the fine grid profiles. For z>1 mm the plume growth on the medium grid starts to lag the growth on the fine grid as evident by the higher temperature profiles for a given time.

All observations relating to temporal evolution of the plume are considered to be qualitative rather than quantitative. First, the axisymmetric domain and boundary conditions restrict temporal evolution—the core of the plume is constrained to the centerline of the domain. Second, the assumption of a steady-state vaporization boundary condition requires a finite amount of time to set up. Given these caveats one notes that contour levels in the base of the plume set up very quickly. Consider, for example the line plot evolution of temperature in FIG. 6 where each line indicates the extent of the temperature profile in 5 ms increments. After only 15 ms the temperature at z=1 mm is within 5% of its value at 40 ms. Species mass fractions follow the same trend.

A check of cell Reynolds numbers Re_{cell}=ρΩΔx/μ across the diffusion layer of the plume on the nominal grid indicate peak values as a function of pressure of 1.1 at 0 psig, 38 at 50 psig, 62 at 100 psig, 94 at 200 psig, 137 at 400 psig, and 241 at 800 psig. Given the small differences between the nominal and fine grid solutions at 200 psig for z>0:1 mm it is assumed that numerical dissipation affects the solution for at least Re_{cell}>90. For z<0:1 mm the diffusion layer is better resolved with at least an order of magnitude reduction in cell size at the foot of plume where gas flow is predominantly in the radial direction. Evidence of grid convergence in the plume base is important because the conditions here drive subsequent plume evolution and define maximum available reservoir levels of BN.

### Chamber Pressure Effects

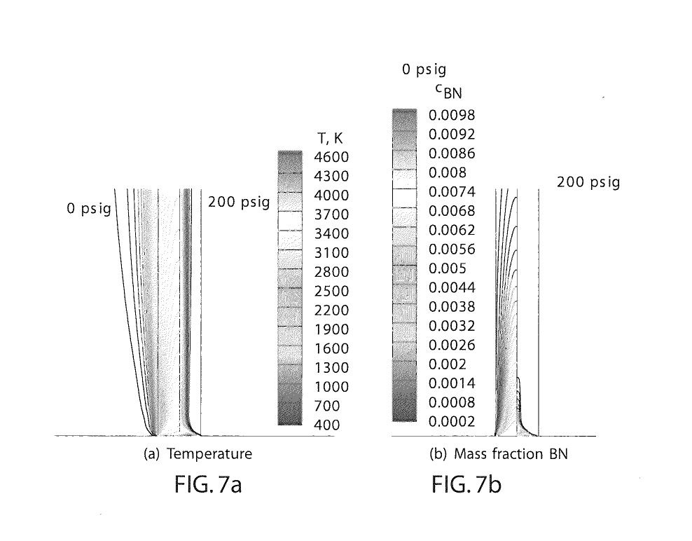

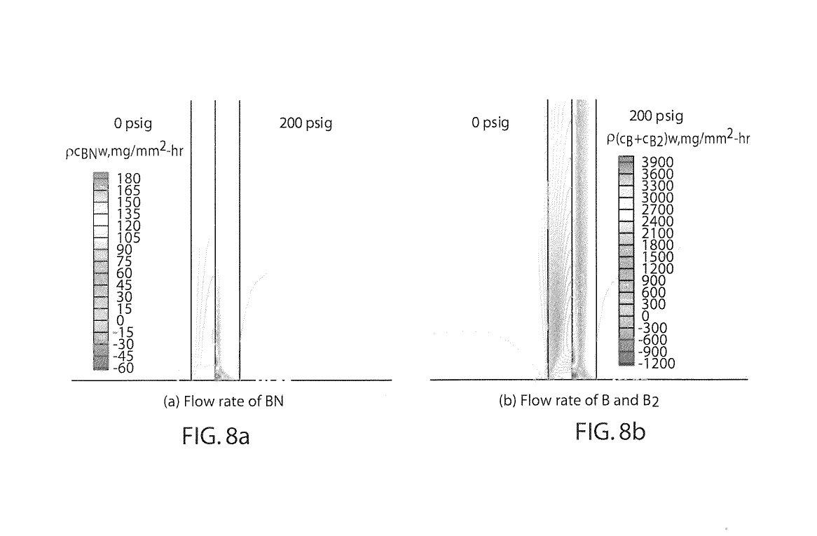

Comparisons of the plume shape and properties at 0 psig (atmospheric pressure) and 200 psig (14.6 atmospheres) are presented in FIGS. 7 and 8. The plume radius expands from the base at 0 psig and contracts at 200 psig for the same delivered power level of 0.1 kW. The vertical black line in these figures to the left arid right of the axis indicate the 1 mm radius corresponding to the radius of the irradiated spot on the boron droplet on the floor of the domain. Peak temperature at the base and peak mass fraction of BN are higher for the 200 psig case compared to the 0 psig case. However, the BN mass fraction at 200 psig declines more quickly. The corresponding flow rates of boron derived species rising to the condenser loop (not shown) are presented for BN in FIG. 8a and for the sum of B and B₂ in FIG. 8b. There is no recirculation pattern at the base of the plume at 0 psig. Results indicate that BN returns to B₂ and N₂ as the plume rises and cools under assumption of equilibrium chemistry and under the assumption of single phase flow. The single phase flow assumption forces a supersaturated level of BN and B in the rising plume. The equilibrium flow assumption may deplete BN faster than collisional processes would allow because the availability of suitable atomic collision partners is diminished in the rising plume as it cools. This issue is discussed in more detail below in the section entitled Gas Chemistry Model Effects.

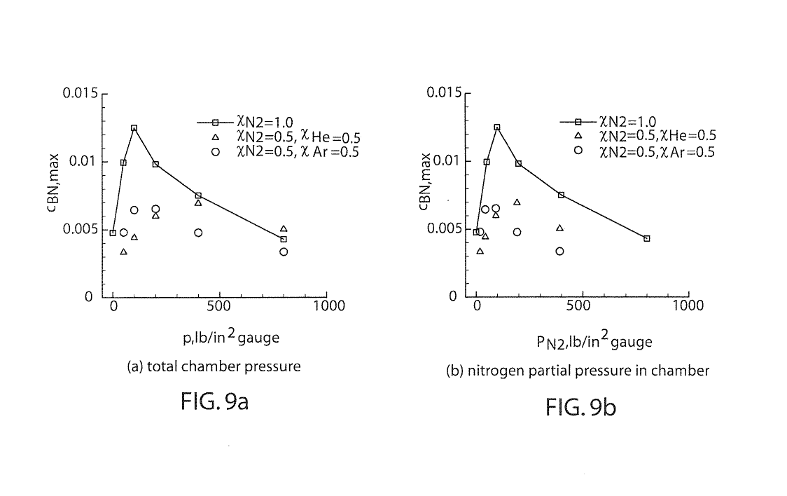

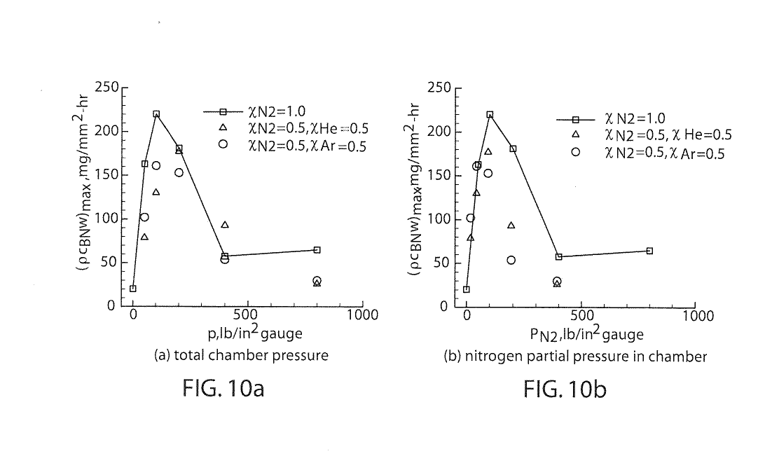

FIGS. 9-11 capture maximum values of key plume environmental variables that tend to drive plume dynamics. These maximum values occur at or near the base of the plume where grid resolution is thought to be adequate (based on the earlier Grid Convergence discussion) to establish the trends associated with chamber pressure. The figures show results as a function of total chamber pressure on the left and as a function of partial pressure of nitrogen in the chamber on the right. Helium and argon were added to the parametric study here to investigate if the presence of a lighter or heavier noble gas may influence the environment in a way to enhance the flow rate of boron-rich gases. (The results shed no light regarding how the presence of noble gases may affect nucleation rates.) Isolating the effect of nitrogen partial pressure is intended to capture the importance of the availability of nitrogen as a reaction partner with boron at the base of the plume. There is no evident advantage to diluting the nitrogen atmosphere with a noble gas based on these results.

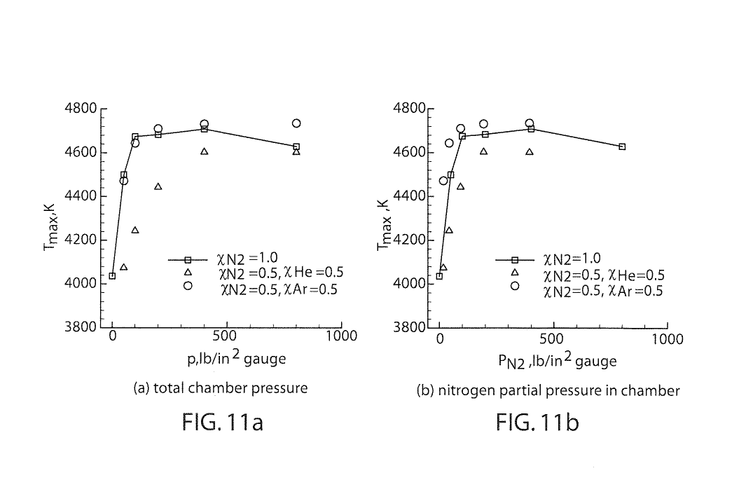

FIGS. 9-11 show a clearly defined peak for BN mass fraction and flow rate between 50 and 200 psig. The maximum values are highest for a pure nitrogen atmosphere though the trends are evident in all of the tested atmospheres. It is thought that rapidly using temperature between 0 and 100 psig accounts for a greater availability of atomic nitrogen which dissociates at temperatures above 4000 K. Beyond 200 psig the increase in peak temperature tapers off (FIG. 11) while dissociation of nitrogen is suppressed for a given temperature as the pressure rises. Consequently, the production of BN diminishes beyond 200 psig. If nucleation from a supersaturated flow of BN is a significant driver to the BNNT production rate or nanotube length then this local maximum is an important process design environmental variable.

### Gas Chemistry Model Effects

Earlier sections on Gas Properties and Chamber Pressure Effects discussed the concern that an equilibrium assumption may cause BN gas to be converted to B₂ and N₂ at an unnaturally high rate because of the limited availability of atomic collision partners. Two chemical kinetic models for the B—N system are proposed based on the C—N system as documented in Table 1. Kinetic model 1 includes all five reactions listed in Table 1. Kinetic model 2 includes only the first 4 reactions listed in Table 1. It omits the final reverse reaction, effectively a double shuffle reaction, in which two molecular boron nitride molecules collide, dissociate, and then recombine into diatomic boron and diatomic nitrogen. Without this reaction, the only path to dissociate BN requires an atomic intermediary as either a collision partner (reactions 3 and 4) or a product (reaction 2).

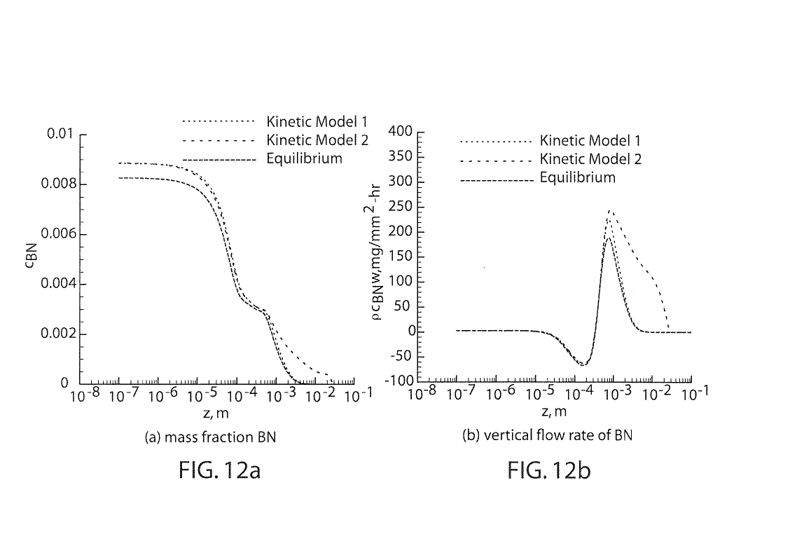

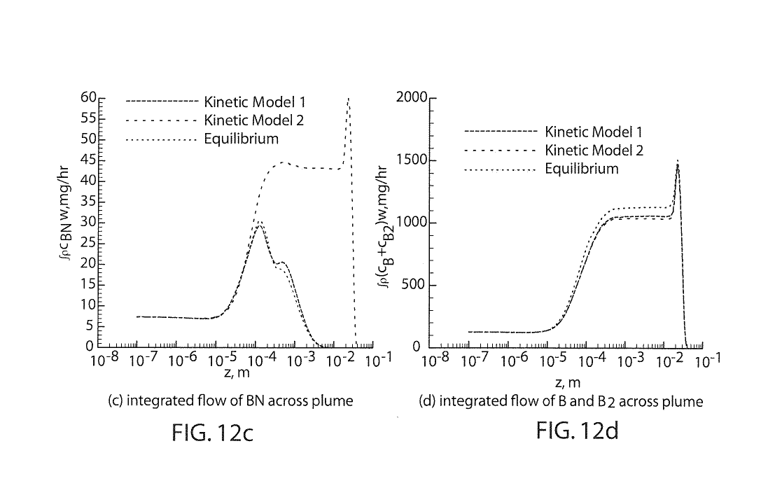

FIG. 12 compares mass fraction, BN flow rate and integrated flow rates across the plume as a function of height. In FIG. 12 the two kinetic models show identical levels of mass fraction c_{BN} in the lower portion of the plume (z<1 mm) extending through the recirculating flow where BN is initially formed. The equilibrium model predicts approximately 10% lower values of c_{BN} in this same region. For z>1 mm kinetic model 1 approaches the equilibrium model while kinetic model 2 shows that BN persists as the plume continues to rise and cool. This trend is also evident in the vertical flow rate of BN FIG. 12 where significant levels of BN persist beyond 2 cm to the top of the plume. The flow rate per unit area is integrated across the area of the plume out to 1 mm radius to show the flow rate of BN in mg/hr in 12(c). An equivalent integration produces the combined flow rate of B and B₂ in mg/hr. The BN flow levels using kinetic model 2 are small compared to B and B₂ but the rate is roughly equivalent to estimated production rates of BNNTs in the PVC process. Although kinetic model 2 results have not been validated experimentally, its formulation using the C—N system template is thought to provide a credible example of how an actual flow would behave.

### Laser Power Effects

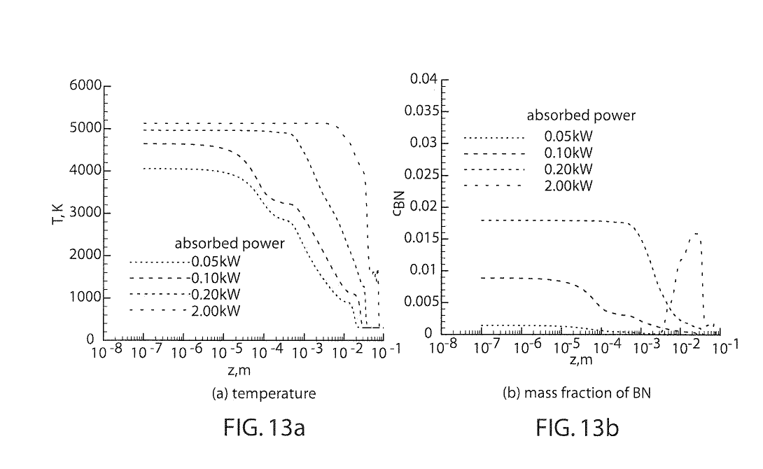

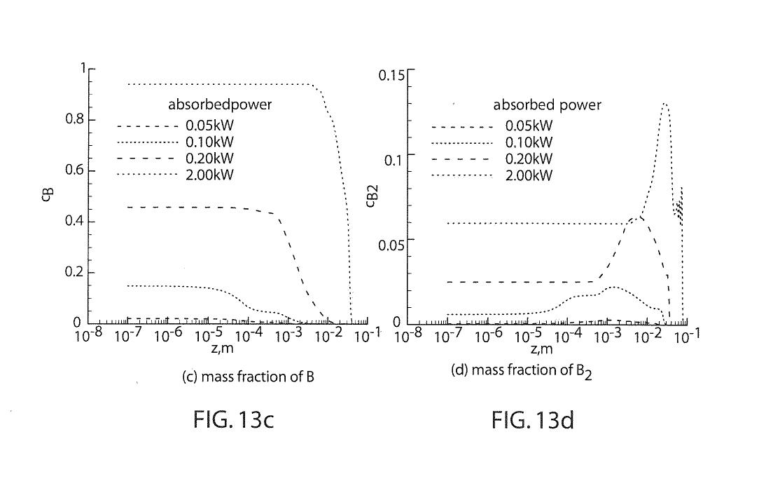

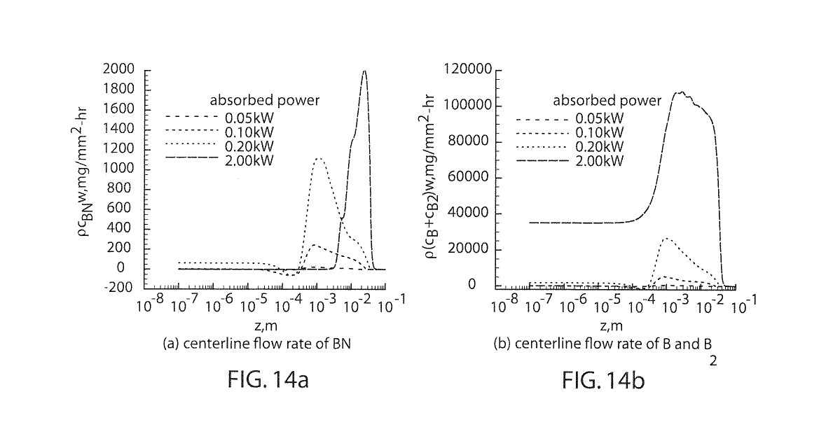

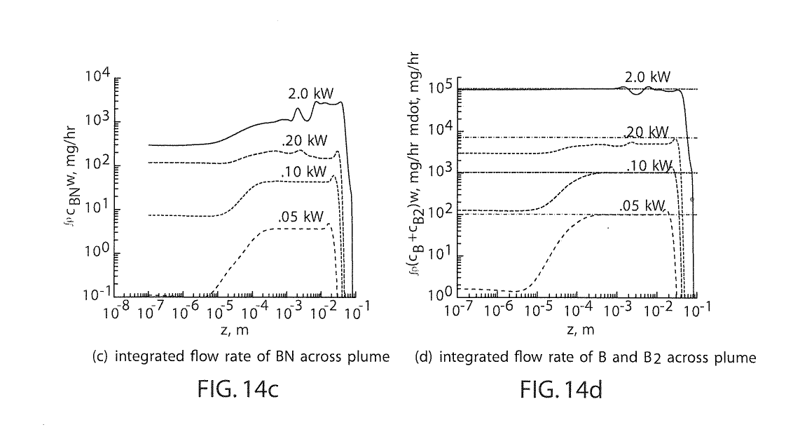

The effects of absorbed laser power to a 1 mm radius spot on plume development are presented in FIGS. 13 and 14. Simulated absorbed power levels include 0.05 kW, 0.1 kW, 0.2 kW, and 2.0 kW in a 200 psig chamber with XN₂=1. Kinetic model 2 is employed in all simulations. The profiles are captured at 80 ms.

As absorbed laser power increases the temperature at the base of the plume (FIG. 13) approaches the boiling point of boron as documented in Table 3. The boiling point is achieved at 2.0 kW and the blowing rate of boron completely displaces nitrogen at the bottom of the plume. The sum of c_{B} and C_{B2} equals 1 for 2.0 kW absorbed power (FIGS. 13c and 13d) and c_{BN} goes to zero as shown in FIG. 13b because no nitrogen is available to react with boron at the droplet surface. (The boiling droplet would not stay suspended from the fiber bundle in the current configuration—it is presented here as an interesting limiting condition.) A dip in the temperature profile at z=0.1 mm for the two lowest power levels is indicative of a recirculation pattern at the base of the plume. As power is increased, the blowing rate increases sufficiently to displace the recirculating flow.

Profiles of the flow rates of boron species are presented in FIG. 14 for each of the four power levels. The centerline rates (FIGS. 14a and 14b) show the convective flux of boron containing species as a function of height. The integrated flow rate (FIGS. 14c and 14d) plots the integral of the rising convective flux of boron containing species from x=0 (centerline) to x=1 mm capturing the vertically convecting mass flux in the entire plume as a function of height. Note that these plots include only the vertical component of convective flux. This component represents almost 100% of the boron flux in the upper portion of the plume. If the plume is unsteady, there can be a significant horizontal component of flux. More importantly, for low blowing rates at lower absorbed power levels, the diffusive component of boron mass flux exceeds the convective component at the base of the plume.

The dashed lines in FIG. 14d denote the vaporization rate of boron from the droplet surface. They are extended across the figure so that one may compare the instantaneous mass loss rate at 0.08 s to the vertical mass flux rate in the established plume. For the two lowest laser power cases agreement is excellent for z>1 mm. For the two highest power cases the simulated plume is unsteady, consequently the integrated flow rate shows variation as a function of height caused by pulsing as a function of time. The difference between the integrated convective flow rate and the vaporization rate for z<0:01 mm indicates the level of diffusive flux of boron leaving the droplet.

The sustained integrated flow rate of BN in the upper part of the plume is approximately 3% of the vaporization rate for all of the power levels at 200 psig. These sustained levels essentially disappear if BN can form B and N₂ at low temperatures without atomic intermediaries as forced by the chemical equilibrium approximation or as allowed in a kinetic model including reaction 5 of Table 1. These sustained levels could rise or fall depending on the kinetics of the real BN system compared to the proposed system simulated here.

The computed integrated vaporization rate {tilde over (\dot{m} for a feeder fiber bundle with density ρ_{rod} and radius r_{rod} is easily transformed to the recession rate of the feeder fiber bundle ż_{rod} with the below Eq. 6.

{tilde over (\dot{m}=ż_{rod}ρ_{rod}πr_{rod}²

Assuming a boron fiber bundle density ρ_{rod} of 2.46 g/cm³ the vaporization rates in FIG. 14d transform to recession rates of 1.33 cm/hr for 0.05 kW, 13.5 cm/hr for 0.1 kW, 93.8 cm/hr for 0.2 kW and 1393 cm/hr for 2.0 kW. For reference, the corresponding heating rates vary from 1592 W/cm² to 63662 W/cm² from the lowest to highest absorbed laser power levels. The fiber bundle recession rate serves as a relatively simple metric to calibrate absorbed power after losses. Its utility does, however, depend to some extent on the ability to achieve a steady state vaporization condition without mechanical loss of droplets from the end of the feeder fiber bundle.

### Experimental Observations Versus Simulations

During actual PVC production processes, it has been observed that significant condensate forms on the condenser loop at locations from approximately 1 cm to 7 cm above the droplet surface. Nominal grid solutions of the simulations described above indicate that it takes 0.16 seconds for the top of the plume to rise to a height of approximately 5 cm. The plume is still slowly rising at this point in time. Plume simulations show greater attained height at equivalent times with greater delivered laser power (lower assumed losses). However, with the current modeling of steady state ablation from a spot on the floor of the chamber these higher power simulations indicate a greater recession rate than estimated from observations. Small perturbations to the current models may make the plume rise faster—for example, reducing the estimated laser spot diameter while increasing delivered power. One potential approach would be to increase fidelity of the laser—droplet—fiber bundle interaction region by expanding the simulation to include the domain around the suspended droplet. This modification exposes more droplet surface to feed the plume and allows an upwelling of nitrogen from below the droplet to potentially assist loft.

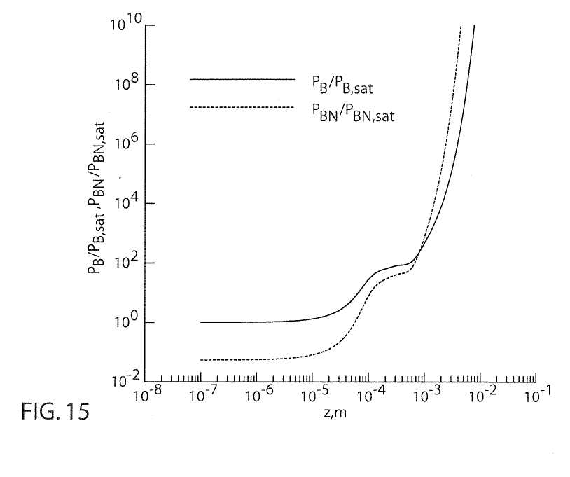

During actual PVC production processes, it has also been observed that the “cotton-like” condensate produced at a rate of 50 to 100 mg/hr contains up to 50% nanotubes by mass. The remaining condensate includes BN particle flakes and solidified boron droplets. Nanotubes are most often seen extending from these droplets suggesting that liquid boron droplet sites are critical to the nucleation of BNNT nanotubes. The simulations described above suggest that a supersaturated state of BN gas in the plume provides a reservoir from which extremely rapid condensation of nanotubes progresses when a “suitable” nucleation site is encountered. The saturated equilibrium vapor pressure of boron with liquid boron, p_{B,sat}, and the saturated equilibrium vapor pressure of BN with hexagonal boron nitride solid, p_{BN,sat}, are calculated as a function of temperature using Eq. 4. Estimated reference triple point conditions used in Eq. 4 for BN are p_{BN}=400±20 Pa,²⁸ T_{BN}=3400±20 K,²⁸ and H_{BN,sub}⁰=669.44 kJ/mol. The reference conditions for B were already discussed in the section on Material Response Model. The local vapor pressure of B and BN non-dimensionalized by the corresponding saturated vapor pressure is presented in FIG. 15. The supersaturation factors exceed 100 for z>1 mm. The simulated mass flux levels of BN, B, and B₂ are sufficiently high to produce the observed levels of condensate formed in the chamber.

Finally, we note that as chamber pressure is increased above 100 psig for absorbed laser power equal to 0.1 kW a recirculation region forms at the base of the plume. Recirculation provides extended residence time in a BN-rich environment for any particles (potential nucleation sites) that enter this region. As noted previously, higher absorbed power levels tend to increase the vaporization rate and displace any recirculation pattern.

Flow in a pressurized, vapor condensation (PVC) boron nitride nanotube (BNNT) production rig is modeled utilizing a hypersonic flow solver such as NASA's Program LAURA. A laser provides a thermal energy source to the tip of a boron fiber bundle in a high pressure nitrogen chamber. The thermal energy source causes a molten droplet to form at the end of the fiber bundle. The boiling point temperature of boron increases with an increase in chamber pressure. The droplet temperature also rises with increasing chamber pressure for a given absorbed power level under assumptions of equilibrium vapor pressure and steady state vaporization. A plume of boron-rich gas rises from the droplet surface. The buoyancy driven flow is modeled as mixture of thermally perfect gases (B, B₂, N, N₂, BN) in either thermochemical equilibrium or chemical nonequilibrium assuming steady-state melt and vaporization.

An idealized, axisymmetric chamber may be used to model the PVC process. The droplet is positioned on the chamber floor at the axis, a 1 mm radius spot is irradiated, and a time-dependent evolution of the plume is simulated. Parametric simulations involving chamber pressure, equilibrium and non-equilibrium gas models, laser power levels, and dilution of nitrogen with noble gases in the chamber are executed. The simulations are intended to define the macroscopic thermochemical environment from which boron-rich species, including nanotubes, condense out of the plume. Only the gas phase is considered. Flow rates of BN vapor are monitored on the assumption that they could contribute to enhanced nucleation rates of BNNTs. The simulations for a nominal condition defined by p₀=200 psig and absorbed laser power of 0.1 kW to a 1 mm radius spot on a molten boron droplet indicate:

1. A high temperature environment (T>4400K) forms within 1 mm of the surface at elevated chamber pressures (p₀≧50 psig) sufficient to dissociate molecular nitrogen and form BN at the base of the plume.

2. BN vapor flow rate exhibits a maximum at the plume base for p₀ somewhere between 50 and 200 psig.

3. Under an equilibrium chemistry model BN is transformed to B₂ and N₂ as gas rises and the plume cools.

4. Under a chemical kinetic model BN vapor flow levels are frozen as the plume continues to rise. The BN flow rate is approximately 3% of the net vaporization rate at p₀=200 psig for absorbed laser power varying from 0.05 kW to 2.0 kW

5. A recirculation region begins to form at the base of the plume at p₀=100 psig. Recirculation provides any existing particulates an opportunity for extended residence time in a BN rich environment, even with the equilibrium gas model.

The simulations indicate that the high pressure environment causes significant levels of BN vapor in the plume that are not present at atmospheric pressure. A supersaturated reservoir of BN vapor is believed to be a significant contributor to the formation of high quality BNNTs produced in the PVC process.

Referring again to FIG. 1, a PVC production system utilizes a number of input parameters. The inputs to the simulation discussed in more detail above can be varied to determine the effects of such variations in input parameters on the BNNT production process. For example, the pressure in pressurized chamber 5 can be varied in the simulation to determine an optimum chamber pressure. The chamber pressure in the production rig can then be set at the pressure value determined from the simulation. Similarly, the flow rate of nitrogen into the chamber, as well as the location of the nozzle/outlet from which the nitrogen is introduced can be varied in the computer simulation. The laser power and shaping characteristics can also be varied in the simulation. Still further, the location size, shape, and other characteristics of the condenser loop 38 can also be varied in the simulation. These various inputs to the simulation can be varied to determine optimum ranges for each of the production process in the PVC production system 1. The PVC production system 1 can then be set up or adjusted to provide the optimum operating parameters determined from the numerical simulation.

The present invention is described in Gnoffo, P. A., and Fay, C. C., “Modeling of Laser Vaporization and Plume Chemistry in a Boron Nitride Nanotube Production Rig,” 43rd AIAA Thermophysics Conference, 25-28 Jun. 2012, New Orleans, La.; hereby incorporated by reference in its entirety.

The present invention is not limited to the specific production system illustrated in FIG. 1. It is to be understood that variations and modifications can be made on the aforementioned structure without departing from the concepts of the present invention, and further it is to be understood that such concepts are intended to be covered by the following claims unless these claims by their language expressly state otherwise. While some embodiments of the invention have been herein illustrated, shown and described, it is to be appreciated that various changes, rearrangements and modifications may be made therein, without departing from the scope of the invention as defined by the appended claims. It is intended that the specific embodiments and configurations are disclosed for practicing the invention, and should not be interpreted as limitations on the scope of the invention as defined by the appended claims, and it is to be appreciated that various changes, rearrangements and modifications may be made therein, without departing from the scope of the invention as defined by the appended claims.

What is claimed as new and desired to be secured by Letters Patent of the United States is:

1. A method of providing operational parameters for a boron nitride nanotube production rig, the method comprising:
providing a computer simulation of a high temperature, pressurized vapor condensation boron nitride nanotube production process;
utilizing the computer simulation to optimize at least one operating parameter of the high temperature, pressurized vapor condensation boron nitride nanotube production process to thereby facilitate formation of boron nitride nanotubes;
utilizing information concerning the one operating parameter from the simulation to set up a boron nitride nanotube production rig.

2. The method of claim 1, wherein:
creating a computer simulation of a high temperature, pressurized vapor condensation boron nitride nanotube production process includes providing thermodynamic and transport property data sets for the boron species B, BN, and B₂.

3. The method of claim 2, wherein:
the simulation includes setting a surface energy balance equation under a laser radiation source based on equilibration of atomic boron vapor pressure with a liquid boron source.

4. The method of claim 3, wherein:
the simulation utilizes momentum equations having buoyancy terms.

5. The method of claim 4, wherein;
the simulation includes a porous wall boundary condition to mimic a pressure relief valve in the system to maintain constant pressure as mass and energy are added to the system.

6. The method of claim 1, wherein:
the simulation comprises modifying a hypersonic flow solver to account for the conditions present during a high temperature, pressurized vapor condensation boron nitride nanotube production process.

7. The method of claim 1, wherein:
the production process utilizes a pressurized chamber, and the one operating parameter comprises pressure in the chamber.

8. The method of claim 1, wherein:
the production process utilizes a pressurized chamber, and the one operating parameter comprises a flow rate of a gas into the pressurized chamber.

9. The method of claim 8, wherein:
the gas comprises nitrogen.

10. The method of claim 1, wherein:
the one operating parameter comprises an amount of power provided by a laser.

11. The method of claim 1, wherein:
the one operating parameter comprises temperature in the chamber.

12. The method of claim 1, wherein:
the production process includes feeding a bundle of boron fibers into a pressurized chamber, and the one operating parameter comprises a rate at which the bundle of boron fibers are fed into the pressurized chamber.

13. The method of claim 1, wherein:
experimental observation is utilized in conjunction with the computer simulation to optimize at least one operating parameter of the high temperature, pressurized vapor condensation boron nitride nanotube production process.

14. A method of modeling laser ablation and plume chemistry of a boron nitride nanotube production process, the method comprising:
providing a hypersonics flow solver;
modeling a pressurized chamber by forming a grid of discrete elements corresponding to the walls of a pressurized chamber;
including boron species to thermodynamic and transport data sets of the hypersonics flow solver, the boron species comprising B, BN, and B₂;
modifying the hypersonics flow solver to provide an energy balance that takes into account energy from a laser radiation source;
executing the hypersonics flow solver to generate a plume and to determine the effect of changes in the production process.

15. The method of claim 14, including:
setting the chamber pressure at a value in the range of approximately 0-800 psig.

16. The method of claim 15, including:
setting a power level supplied from the laser in the range of approximately 0.05-5.0 KW.

17. The method of claim 14, wherein:
the hypersonics flow solver includes momentum equations; and including:
providing buoyancy terms in momentum equations of the hypersonics flow solver.

18. The method of claim 14, wherein:
the model includes a porous wall boundary condition to simulate a pressure relief valve in the system to maintain constant pressure as mass and energy are added to the system.

19. The method of claim 14, including:
utilizing the solver to determine a mass fraction of BN in the plume.

20. The method of claim 14, including:
utilizing the solver to determine a flow rate of at least a selected one of BN, B, and B₂ in the plume.
